(19) United States
(12) Patent Application Publication
(10) Pub. No.: US 2005/0199300 A1
(43) Pub. Date: Sep. 15, 2005

(54) Proportional pressure control valve

(76) Inventors: Georg Gierer, Kressbronn (DE); Karlheinz Mayr, Bregenz (AT); Thilo Schmidt, Meckenbeuren (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/515,530

(22) PCT Filed: May 17, 2003
(86) PCT No.: PCT/EP03/05213

§ 371 Date: Nov. 23, 2004

(30) Foreign Application Priority Data
May 24, 2002 (DE) 102 22 936.8

(51) Int. Cl. F15B 13/044

(52) U.S. Cl. 137/625.65

(57) ABSTRACT

A proportional pressure control valve is described, which comprises a valve part (1) with outlet and inlet openings (4) and at least one closing element (2) for the control of an orifice (5). The hydraulically effective cross-section of the valve part (1) is determined by the size and shape of the inlet opening (4). The axial longitudinal axis of the inlet opening (4) is perpendicular to the longitudinal axis of the closing element (2). The resultant force action on the closing element (2) has an advantageous effect on the quality of the valve function especially at low temperatures.

The present invention concerns a proportional pressure control valve for the control of an orifice, of the type defined in more detail in the preamble of Claim 1.

A valve of such type is known, for example, from published application DE 100 349 59 A1 by the present applicant. The valve described has an inlet opening and an outlet opening, and closing means for the control of an orifice. The hydraulically effective cross-section in the valve is determined by the size of the orifice and the diameter of the component that enters into the orifice. Here, the orifice acts in combination with the component that enters it as a control valve with an annular cross-section. As the closing means, in particular a ball is proposed, which ensures comparatively good sealing properties while not demanding great precision of the individual components.

The disadvantages of the prior art described are, on the one hand, the annular throttling cross-section, whose tolerances are critical and which has a small hydraulic diameter and, on the other hand, the aperture cross-section of the ball with a throttle length that depends on the opening travel. At lower temperatures when the viscosity of the hydraulic working medium increases, both these factors lead to dynamical problems in the valve.

The purpose of the present invention is to improve the dynamical behavior of a proportional pressure control valve at low temperatures so that control and regulation by means of the proportional pressure control valve will be of consistently good quality over its entire working range.

The objective addressed by the invention is achieved by a proportional pressure control valve of the type in question which also has the characterizing features of the principal claim.

According to the invention, the proportional pressure control valve comprises a valve part with an inlet opening integrated in the valve housing. The hydraulic working medium flows through this inlet opening into a valve space in which there is another opening in the form of an orifice.

Closing means control the orifice and so regulate the quantity of hydraulic working medium flowing through. The closing element is actuated by an actuation element that projects through the orifice into the space of the valve part.

In contrast to the known proportional pressure control valves, which have an orifice and an actuation element that projects into the orifice to control their hydraulically effective cross-section; in this invention, the hydraulically effective cross-section is determined by the inlet opening. Thus, according to the invention, the inlet opening acts as a throttle. This considerably increases the design options for the throttle. For example, it is quite simple to choose the most suitable shape for the hydraulically effective cross-section. Without problems, it is possible to convert from the previously customary annular throttle cross-section, which has the aforesaid negative characteristics at lower temperatures, to a hydraulically more favorable throttle cross-section such as a disk-shaped one. The reason for the hydraulically favorable behaviour of a throttle with disk-shaped cross-section compared with a throttle having an annular cross-section relates to their different respective hydraulic diameters. The hydraulic diameter depends on the surface area wetted by the hydraulic working medium. In the case of an annular cross-section, owing to the presence of an inner boundary, the wetted area is larger than with a disk-shaped cross-section. The size of the wetted area is inversely related to the size of the hydraulic diameter. Accordingly, the hydraulic diameter is smaller with an annular cross-section than with a disk-shaped cross-section. At low temperatures, a smaller hydraulic diameter gives rise to laminar flow, which is logarithmically related to the temperature-dependent viscosity of the hydraulic working medium. In contrast, at low temperatures a larger hydraulic diameter gives rise to turbulent flow, which is affected mainly by the density of the hydraulic working medium and is only linearly related to the temperature-dependent viscosity of the hydraulic working medium.

Thus, a larger hydraulic cross-section results in greater temperature-independence of the hydraulic working medium.

The arrangement of the inlet opening in the valve part, according to the invention, has the further advantage of producing a pressure level suitable for the actuation of the closing means.

According to the invention, the inlet opening is arranged so that the flow direction of the hydraulic working medium flowing through the inlet opening is perpendicular to the axial longitudinal axis of the closing means. This ensures that in the closed condition mainly radial forces act on the closing means. Thus, so-termed jet deflectors in the valve part can advantageously be dispensed with.

Now, starting from the closed position of the valve, if the closing element is opened by means of the actuation element, then compared with the usual proportional pressure valve designs the axial hydrodynamic and hydrostatic opposing forces to be overcome are substantially lower. This results in a performance curve of the proportional pressure regulator that is independent of the inflow pressure, so that the pressure reduction valve usually connected upstream from the pressure regulator can be omitted.

The actuation element is not connected solidly to the closing means. It only exerts an axial force on the closing element during the opening of the latter. The axial opposing force that has to be applied in order to close the closing element again, can be applied either mechanically, for example by a spring or hydraulically. These closing mechanisms are described in more detail in the example embodiments.

Optionally, during its axial movement the actuation element can enter a friction-force-retaining recess of the closing element and is thereby advantageously held radially. The radial retention of the actuation element in the closing element then replaces any necessary additional retention of the actuation element within the proportional pressure control valve. Thus, material and manufacturing costs and also the weight of the proportional pressure control valve can be reduced.

A further advantage of the invention results from the loose connection of the actuation element and the closing means. Whereas in known designs of the valve part of the proportional pressure control valve, deposits of dirt particles between the housing and the closing means result in functional limitations of the valve, the design of the valve part, according to the invention, is unaffected by dirt. In the structure of the valve part, the actuation element can be moved virtually without resistance, even when the closing means would otherwise be likely to stick due to deposited dirt particles.

Furthermore, the proportional pressure control valve is made as in DE 100 349 59 A1. Thus, DE 100 349 59 A1 is integral to the disclosure of the present invention.

Other advantageous design features of the invention emerge from the description below, of example embodiments illustrated in detail in the figures, which show:

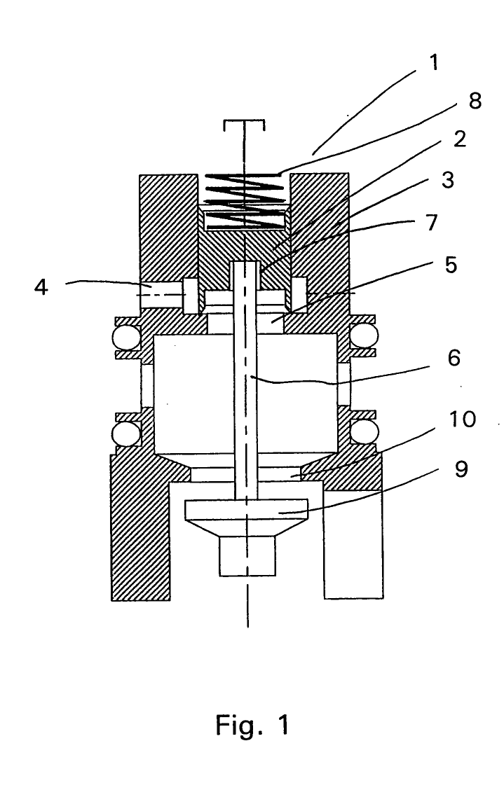

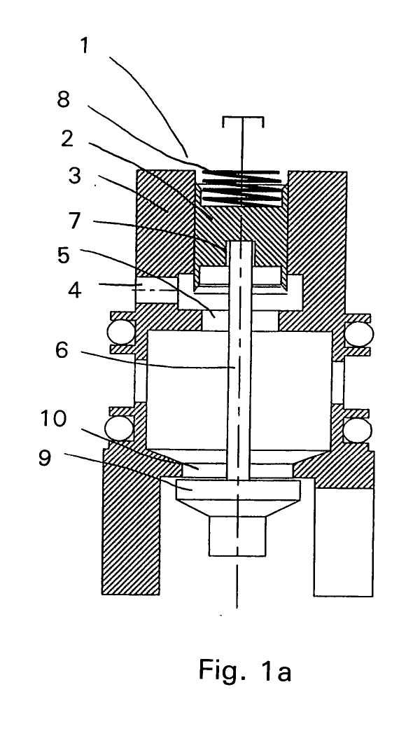

FIG. 1 is a sectional representation of the valve part of the proportional pressure control valve, according to the invention, with its closing means open and closed, closure being effected mechanically by means of a spring; and

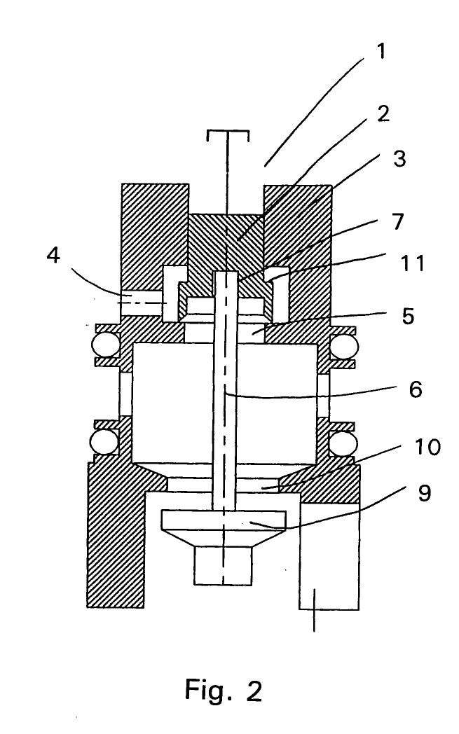

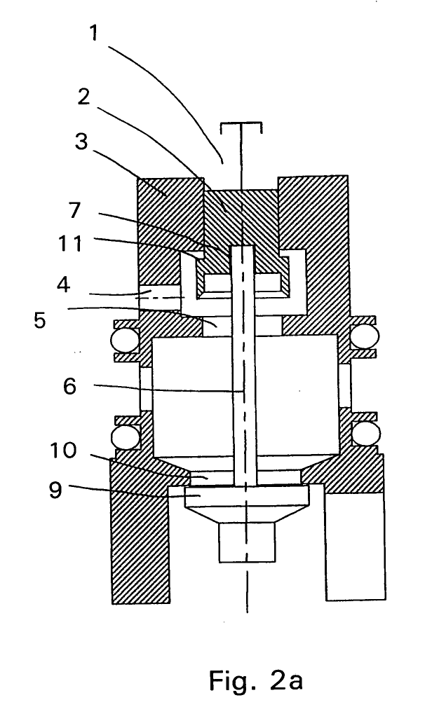

FIG. 2 is a sectional representation of the valve part of the proportional pressure control valve, according to the invention, with its closing means open and closed, closure being effected hydraulically.

FIG. 1 shows a valve part 1 according to the invention, in a sectional representation in the open switching position with the closing means closed on the left and, in the closed switching position, with the closing means open on the right.

An inlet opening 4 is shown, which is integrated in a valve housing 3. Also integrated in the valve housing 3 is a closing element 2, which can be guided with friction force retention in the axial direction of the valve part 1. The longitudinal axis of the inlet opening 4 is perpendicular to the longitudinal axis of the closing element 2. As made clear by the sectional representation on the left, the result of this is that, in the closed condition, the hydraulic working medium flows exclusively around the side surfaces of the closing element 2. Thus, no axial force due to the hydraulic working medium acts on the closing element 2. The axial forces acting on the closing element 2 are produced first by a spring 8 in contact with the closing element 2 in the axial direction on the tank side, and then by an actuation element 6. The actuation element 6 is solidly connected to the armature of the proportional pressure control valve. It projects through the orifice and enters a recess of a closing means 7. The recess of the closing means 7 is sized relative to the actuation element 2 such that it holds the latter by friction force, and so provides radial retention of the actuation means 2. For that reason no further radial retention for the actuation element 2 or armature need be provided in the proportional pressure control valve.

During a closing process of the valve part 1, magnetic forces move the armature connected to the actuation element 6, so that a flat area 9 comes in contact with a valve seat 10. During this, the actuation element 6 also opens the closing element 2 against the force of the spring. In the reverse direction, there is no axial pressure force on the actuation element 6 and the closing element 2 is closed by the spring 8.

The closing element 2 is designed such that the outer periphery of the side facing an orifice 5 has an accurately definable area when the closing element 2 is closed. This embodiment of the closing element 2, according to the invention, enables the forces on the closing element 2 to be determined accurately. The size of the spring 8 can, therefore, be chosen appropriately.

In FIG. 2, the example embodiment of the invention differs from the example embodiment shown in FIG. 1 in that the closing element 2 is closed not by a spring 8, but hydraulically.

The closing element 2 has a differential surface 11. The differential surface 11 is produced by reducing the outer circumference of the closing means 2. This produces a free surface parallel to the contact surface of the closing element 2 on the orifice side, around which the hydraulic working medium constantly flows. On the differential surface 11 there acts a hydraulic force which is large enough to close the closing means as soon as the axial pressure force of the actuation means on the closing element 2 is reduced.

1-12. (canceled)

13. A proportional pressure control valve comprising;
a valve part (1) having inlet (4) and outlet openings and at least one closing means (2) for the control of an orifice (5) at one of the openings and a hydraulically effective cross-section for regulating the quantity of hydraulic working medium flowing through;
a magnet part with a magnetic core, a solenoid and a magnetic armature arranged so that the magnetic armature can be displaced; and
an actuation element (6) that cooperates with the armature, which actuates the closing means (2), such that one or more of the actuation element (6) and the magnet armature is mounted in the magnet part,
such that the hydraulically effective cross-section is positioned in a through-flow direction of the hydraulic working medium ahead of the closing means (2), wherein the surface of the closing means (2) facing towards the orifice (5) can be guided so that only outer areas of the closure means (2) contact the orifice (5).

14. The proportional pressure control valve according to claim 13, wherein the hydraulically effective cross-section consists of the inlet opening (4) in the valve part (1).

15. The proportional pressure control valve according to claim 13, wherein the inlet opening (4) is formed in the valve part (1) in such manner that a flow direction of the hydraulic working medium flowing through the inlet opening (4) is perpendicular to the axial longitudinal axis of the closing means (2).

16. The proportional pressure control valve according to claim 13, wherein the closing means (2) is axially guided by the actuation element (6).

17. The proportional pressure control valve according to claim 13, wherein a connection between the closing means (2) and the actuation element (6) is loose.

18. The proportional pressure control valve according to claim 13, wherein the actuation element (6) and the magnet armature have a single radial mounting in the closing means (2).

19. The proportional pressure control valve according to claim 13, wherein a recess (7) is formed in the closing means (2), into which the actuating element (6) enters and is held radially thereby.

20. The proportional pressure control valve according to claim 13, wherein the closing means (2) has a differential surface (11) upon which acts a pressure force produced by the hydraulic working medium and which brings about closure of the closing means (2).

21. The proportional pressure control valve according to claims 13, wherein the differential surface (11) is produced by reducing a cross-section of the closing means (2) within a space filled by the hydraulic working medium.

22. The proportional pressure control valve according to claims 13, wherein a spring (8) is in contact with the closing means (2) in the axial direction, and the spring (8) brings about the closure of the closing means (2).

23. The proportional pressure control valve according to claim 22, wherein a surface of the closing means (2) facing towards the orifice (5) is formed in outer areas such that a defined enclosed area can be determined, which is equivalent to forces that determine the valve function.
